(19) United States
(12) Patent Application Publication
(10) Pub. No.: US 2005/0120902 A1
(43) Pub. Date: Jun. 9, 2005

(54) Edge transfer lithography

(76) Inventors: David Adams, New York, NY (US); Oksana Cherniavskava, New York, NY (US)

Correspondence Address: BAKER & BOTTS, 30 ROCKEFELLER PLAZA, NEW YORK, NY, 10112, US

(21) Appl. No.: 10/470,230

(22) PCT Filed: Apr. 25, 2002
(86) PCT No.: PCT/US02/13154

Related U.S. Application Data
(60) Provisional application No. 60/286,755, filed on Apr. 25, 2001.

(51) Int. Cl. B41C 1/00

(52) U.S. Cl. 101/483

(57) ABSTRACT

A method for applying a nanoscale resolution pattern of a molecular link onto a surface of a substrate is disclosed. The method referred to as edge transfer lithography, comprises providing a stamp structure (10) having a surface (11) with at least one protruding feature (16). Each protruding feature (16) has a stamp surface of a respective predefined shape at a protruding end thereof. Each protruding feature and its stamp surface are bounded by at least one edge (19), which edge intersects the surface of the stamp structure to form a recess. A solution of the molecular ink and a solvent is applied of the surface of the stamp structure (10) are such that the solution dewets from the surface of the stamp structure (10) is then dried to evaporate the solvent.

### CROSS-REFERENCE TO RELATED APPLICATION

This application claims priority from U.S. Provisional Application Ser. No. 60/286,755, filed Apr. 25, 2001.

### BACKGROUND OF THE INVENTION

1. Field of the Invention

This invention is directed at a method for applying a molecular ink onto a substrate surface. In particular, this invention is directed at a method for applying self-assembled molecular monolayers onto a surface at high resolution.

2. Background Information

Lithographic methods have played a major role in the development of modern microelectronics and are expected to be of central importance in the developing fields of nanotechnology and molecular electronics. A current challenge in the lithographic field is to control the lateral placement of molecules on surfaces with a resolution, or line width, under 100 nm.

Two methods have been recently developed for direct writing and patterning of surfaces with molecular nanostructures and self-assembled monolayers (SAMs): dip-pen nanolithography (DPN), described, for example, in Piner, R. D., Zhu, J., Xu, F., Hong, S., and Mirkin, C. A., “‘Dip-Pen’ Nanolithography,” Science, Vol. 283 (1999), pp. 661-63; and micro-contact printing (μP), described, for example, in Xia, X., and Whitesides, G. M., “Soft lithography,” Angewandte Chemie International Edition in English, Vol. 37 (1998), pp. 550-74, and in U.S. Pat. No. 6,060,121. μCP utilizes a molded “stamp” to print “molecular inks” such as alkane thiols on gold, as described, for example, in Jeong, N. L., Nuzzo, R. G., Xia, Y., Mrksich, M., and Whitesides, G. M., “Patterned Self-Assembled Monolayers formed by Microcontact Printing: Direct Selective Metalization by Chemical Vapor Deposition on Planar Substrates,” Langmuir, Vol. 11 (1995), pp. 3024-26, and siloxanes on silicon or silica surfaces, as described, for example, in Xia, Y., Mrksich, M., Kim, E., and Whitesides, G. M., “Microcontact Printing of Octadecylsiloxane on the Surface of Silicon Dioxide and its Applications in Microfabrication,” Journal of the American Chemical Society, Vol. 117 (1995), pp. 9576-77. The term “stamp” as used herein refers to a structure having a surface with one or more features protruding from the surface, wherein each of the one or more protruding features has a stamp surface bounded by at least one edge, and each pair of adjacent protruding features defines an inner recess. The stamps can be prepared by using a silicon wafer having a desired pattern of grooves formed by photolithography as a mold. The resulting stamps have a structure which mirrors the topographic structure of the silicon wafer template. The term “molecular ink” as used herein refers to a substance that can be transferred from a stamp onto the surface of a substrate, such as glass, by contacting the stamp with the substrate surface. In the case of conventional μCP, the stamp surfaces are wetted with the molecular ink so that the ink is transferred from the stamp surface to the surface of the substrate. The substance may be a compound or a mixture of compounds. μCP may be used to make a wide variety of arrays of patterned SAMs on substrate surfaces. However, because the molecular ink is transferred from the stamp surfaces of the protruding features of the stamp, the line width which can be achieved with μCP is typically only about 500 nm or higher, although sub-500 nm line widths have been reported by Delamarche, E., et al., “Transport Mechanism of Alkanethiols during Microcontact Printing on Gold,” Journal of Physical Chemistry B, Vol. 102 (1998), pp. 3324-34. DPN employs an atomic force microscope (AFM) probe to deliver molecules from the probe surface to a substrate. It is believed that the delivery takes place via a meniscus of water between the probe and the substrate. DPN can achieve feature sizes on the order of 100 nm and is therefore superior to μCP in this respect. However, DPN has the disadvantage of requiring expensive and sophisticated apparatus, and of serial “writing” of a pattern to be transferred to the surface of the substrate. Consequently, the technique is practical only to the production of patterns over a small area, typically up to 100 μm in a given dimension.

There is therefore a need in the art for a method for nanolithography that provides line widths comparable to that achieved with DPN while maintaining the simplicity and broad applicability of μCP.

### SUMMARY OF THE INVENTION

The foregoing need is substantially satisfied by the present invention which in one aspect is a method for applying a nanoscale resolution pattern of a molecular ink onto a surface of a substrate. The method comprises providing a stamp structure having a surface with at least one protruding feature extending from the stamp structure surface by a common distance. Each protruding feature has a stamp surface of a respective predefined shape at a protruding end thereof. Each protruding feature and its stamp surface are bounded by at least one edge, and each edge intersects the surface of the stamp structure to form a recess. A solution of the molecular ink and a solvent is applied to the surface of the stamp structure, including each stamp surface. The solution and the material of the surface of the stamp structure are such that the solution dewets from the surface of the stamp structure, including each stamp surface, so as to accumulate in each recess. The surface of the stamp structure, including each stamp surface, is then dried to evaporate the solvent and leave the molecular ink in each recess with substantially no molecular ink being left on each stamp surface. Each stamp surface is then brought into contact with the surface of the substrate to transfer the molecular ink from each recess to the surface of the substrate along each edge of each protruding feature.

Another aspect of the present invention is an article of manufacture made using the foregoing method.

Still another aspect of the present invention is a method for applying a nanoscale resolution pattern of a molecular ink onto a surface of a substrate and depositing a monolayer of a substance on the pattern of the molecular ink on the surface of the substrate. The method comprises providing a stamp structure having a surface with at least one protruding feature, each protruding feature extending from the stamp structure surface by a common distance. Each protruding feature has a stamp surface of a respective predefined shape at a protruding end thereof. Each protruding feature and its stamp surface are bounded by at least one edge. Each edge intersecting the surface of the stamp structure to form a recess. A solution of the molecular ink and a solvent is applied to the surface of the stamp structure, including each stamp surface. The solution of the molecular ink and the material of the surface of the stamp structure are such that the solution dewets from the surface of the stamp structure, including each stamp surface, so as to accumulate in each recess. The surface of the stamp structure, including each protruding feature, are then dried to evaporate the solvent and leave the molecular ink in each recess with substantially no molecular ink on each stamp surface. Each stamp surface is then brought into contact with the surface of the substrate to transfer the molecular ink from each recess to the surface of the substrate along each edge of each protruding feature so as to apply the nanoscale resolution pattern of the molecular ink onto the surface of the substrate, wherein the molecular ink is covalently bound to the surface. A monolayer of the substance is then deposited from a solution containing the substance on the pattern of molecular ink on the surface of the substrate by using one of casting, spin-coating and dip-coating.

The method of the invention, which is referred herein as edge transfer lithography, or ETL, maintains the simplicity and broad applicability of μCP and at the same time substantially reduces the feature sizes which are possible with the μCP approach because molecular ink is transferred to the substrate surface along each edge of each protruding feature, rather than from each stamp surface. A resolution of up to 60 nm line width can be obtained with ETL. ETL is relatively simple to implement, in contrast to DPN and other nanometer patterning techniques such as E-beam lithography, AFM and STM (scanning tunneling microscopy) modification of surfaces, each of which requires expensive and sophisticated apparatus for their implementation. Accordingly, ETL provides a simple and widely applicable way of patterning the surface of a substrate with nanoscale features over relatively large areas. ETL may also be used to form high-order junctions through multiple applications of the ETL stamping process.

The “molecular ink” is preferably a substance containing a compound capable of forming SAMs on the substrate surface and which dewets from the stamp structure surface, including each stamp surface. The patterned SAMs render possible the guided assembly of molecular materials. Therefore, ETL may also be used to create complex patterned nanoscale 3-dimensional structures, with applications in molecular and nanoscale electronics, chemosensing, surface science, catalysis, and the biological sciences.

### BRIEF DESCRIPTION OF THE DRAWINGS

FIG. 1A is a schematic illustration of the ETL process of the present invention.

FIG. 1B is a schematic illustration of a possible mechanism for molecular transport of alkylsilanes from the edge of a stamp feature to the glass substrate via an adsorbed water meniscus.

FIG. 1C shows a reverse scan direction LFM 3-D image of a 1.5×1.5 μm clover-shaped SAM of dimethyldodecylchlorosilane (DDCS) deposited onto a glass surface.

FIGS. 1D-E show idealized structures of a liquid crystal/SAM bilayer assembly formed in accordance with the present invention.

FIGS. 2A-2E show scanning probe microscopy images of self assembled monolayers of DDCS patterned on glass using an elastomeric stamp.

FIGS. 2F-2H show images of liquid crystal/SAM assemblies obtained by overlaying DDCS self-assembled monolayers with a liquid crystal monolayer in accordance with the present invention.

FIG. 2I shows images of self assembled monolayers of DDCS patterned on glass using an elastomeric stamp with a line pattern in accordance with the present invention.

FIG. 2J shows images of self assembled monolayers of titanium dioxide patterned on glass using an elastomeric stamp in accordance with the present invention.

FIGS. 2K and 2L show NC-AFM images of CdSe nanoparticles overlaying DDCS self-assembled monolayers formed in accordance with the present invention.

FIGS. 3A-E shows topographic line scans obtained from NC-AFM images.

### DETAILED DESCRIPTION OF THE INVENTION

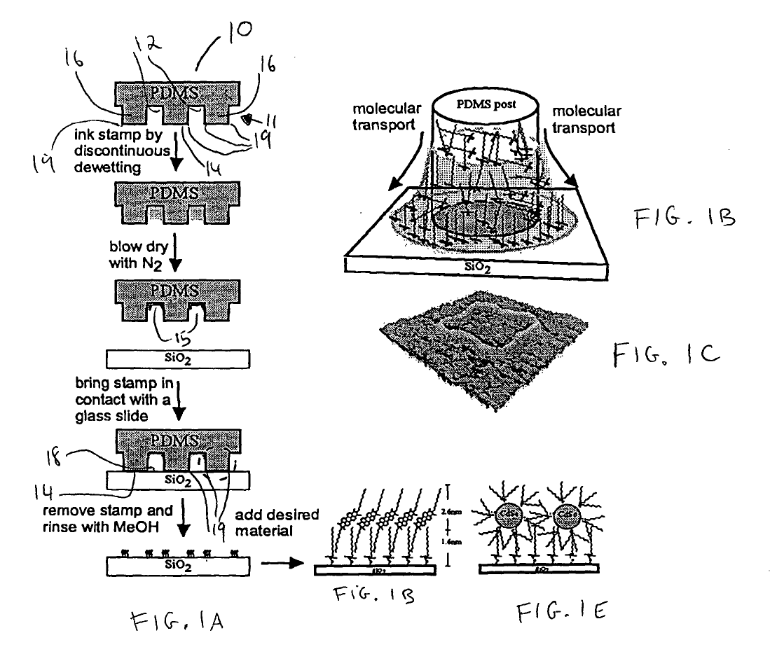

Referring to FIG. 1A, stamp structure 10 used in the method of the invention comprises a surface 11 having protruding features 16 each having a respective stamp surface 14 of a predetermined shape bounded by one or more edges 19, each extending from the stamp surface 14 to a respective non-protruding portion of the stamp structure surface 11. Each protruding feature extends from the stamp structure surface 11 by a common distance. The intersection 19 of each edge 14 and the stamp structure surface 11 forms a recess 12.

In an exemplary embodiment of the present invention, each recess 12 has a scale on the order of a micron. In an advantageous embodiment of the invention, the stamp structure surface 11 is formed with an elastomeric material. In an especially advantageous embodiment, the stamp structure surface 11 is made from a polymeric material. An especially advantageous polymeric material is polydimethoxysilane (PDMS). The PDMS stamps may be molded using a silicon wafer having a desired pattern of grooves formed by photolithography or other standard methods as the mold. After molding, the stamp is cleaned with chloroform to remove any low molecular weight polymer from the stamp. The protruding features 16 and their respective stamp surfaces 14 can be of any shape. For illustrative purposes, stamp surfaces 14 of each of the protruding features 16 are shown in FIG. 1A as having an essentially rectangular shape.

The solvent in which the molecular ink is dissolved is a polar solvent. In an advantageous embodiment, the polar solvent is a solvent that readily dewets from the PDMS surface and causes substantially no swelling of the PDMS surface. An alcohol such as ethanol is advantageous over a non-polar solvent such as hexane, hexadecane and toluene, which does not dewet readily from the PDMS surface and which swells the PDMS stamp structure surface 11. The stamp structure surface 11, including each stamp surface 14, is typically inked with a fresh solution of the molecular ink in a concentration ranging between 1% and 5% by volume in anhydrous ethanol or methanol, whereupon the solution of the molecular ink discontinuously dewets from the stamp structure surface 11, including the stamp surface 14 of each protruding feature 16, and leaves molecules of the solvent and of the molecular ink 15 accumulated in the recesses 12 of the stamp structure surface 11, as shown in FIG. 1A. Discontinuous wetting and dewetting has been described in the context of filling arrays of PDMS microwells in Jackman, R. J., Duffy, D. C., Ostuni, E., Willmore, N. D., and Whitesides, G. M., Analytical Chemistry, Vol. 70 (1998), pp. 2280-87. After the molceular ink solution is applied to the stamp structure surface 11, the surface 11 is blown dry preferably using nitrogen gas so as to evaporate the solvent and leave only a small amount of molecular ink on the stamp surfaces 14 of the protruding features 16, while a large reservoir of molecular ink is left in the recesses 12 of the stamp structure 11. When the stamp surfaces 14 of the protruding features 16 of the stamp structure surface 11 are brought into contact with substrate surface 18, the molecular ink is delivered from the recesses 12 along the edges 19 of the protruding features 16 so as to produce on the surface 18 of the substrate large area patterns with nanoscale features.

The molecular ink is a compound capable of forming self-assembled monolayers and of reacting with hydroxyl groups, which may be hydroxyl groups on a substrate surface 18, and with water, to form a covalent bond with the oxygen atom. In one advantageous embodiment, the compound is an alkylsilane substituted with a polar group. The polar group can be, for example, a leaving group, where the term “leaving group” as used herein refers to a functional group that can be displaced by a nucleophilic group. In one particularly advantageous embodiment, the alkylsilane is selected from the group consisting of monochloro alkylsilanes and monoalkoxy alkylsilanes. Among monoalkoxy alkylsilanes, monomethoxy alkylsilanes are especially advantageous. In another exemplary embodiment, the molecular ink compound is a metallic compound that is soluble in a liquid alcohol or a mixture of water and a liquid alcohol. One such advantageous metallic compound is titanium dioxide, TiO₂, more particularly titanium dioxide nanoparticles ranging from about 3 to about 7 nm in diameter. These nanoparticles may be dissolved in ethanol or in ethanol:water mixtures in which the volume percentage of water in the solvent varies from about 0.02% to about 3% by volume. The concentration of titanium dioxide varies from about 3×10⁻³ to about 9×10⁻⁴ mg/ml. For the above values of water percentage and titanium dioxide concentration, patterns having narrow line widths of titanium dioxide ink transferred from the edges 19 of the protruding features of the stamp structure surface 11 are obtained. At higher levels of water percentage and titanium dioxide concentration, more titanium dioxide ink is left on the stamp surfaces 14 of the protruding features 16 of the stamp structure surface 11 so as to produce more “filled-in” patterns on the substrate surface 18.

In a further exemplary embodiment of the invention, the molecular ink is capable of forming on the substrate surface 18 a monolayer onto which may be deposited a monolayer of a substance that is not covalently bound to the molecular ink. Preferably, the molecular ink is covalently bound to the surface groups on the substrate surface 18, such as hydroxy groups. In an advantageous embodiment of the invention, the substance that is not covalently bound to the molecular ink may be a liquid crystal material. Perylene derivatives are especially suitable liquid crystal materials for this purpose. In another advantageous embodiment of the invention, the substance that is not covalently bound to the molecular ink may be a semiconductor. Cadmium-selenium (CdSe) nanoparticles represent an especially suitable semiconductor material for this purpose.

The substrate of the invention may be a conductor, such as a metal, a non-conductor, or a semiconductor. In an advantageous embodiment, the substrate is made of glass, a polymeric material, or an inorganic material such as a ceramic. In an especially advantageous embodiment, the substrate is a glass slide having a surface that is freshly cleaned with a strong oxidant, such as a concentrated solution of sulfuric acid and hydrogen peroxide in water. In another advantageous embodiment, the glass slide and the stamp surface or surfaces 14 are brought into contact immediately after the drying or blow-drying step described above. Referring to FIG. 1A, the glass slide surface 18 and the stamp surfaces 14 of the protruding features 16 of the stamp 10 are brought into contact to cause the transfer of the molecular ink from the stamp structure surface 11 to the glass slide surface 18 along the edges 19 of the protruding features 16. In a further embodiment of the invention, the stamp structure 10 and glass slide are baked while in contact at 70° C. for at least one hour. After the stamp is removed from the glass slide, the glass slide may be further baked at about 70° C. for at least one hour, preferably between one and 12 hours, to further bind the molecular ink to the glass surface 18.

The stamp structures 10 used in the invention have protruding feature sizes of about 1 to about 5 μm, where the term “feature size” as used herein denotes the width 11 of the stamp surface 14 of each protruding feature 16 in FIG. 1A. PDMS stamps with stamp surface sizes below about 2 μm are observed to have significantly reduced contact areas. The result appears to be due to solvent swelling which makes the stamp surfaces 14 of the protruding features 16 concave thereby reducing the contact area of the stamp surfaces 14 of the protruding features 16 with the substrate surface 18, so that virtually all the molecular ink is transferred from the edges of the protruding features.

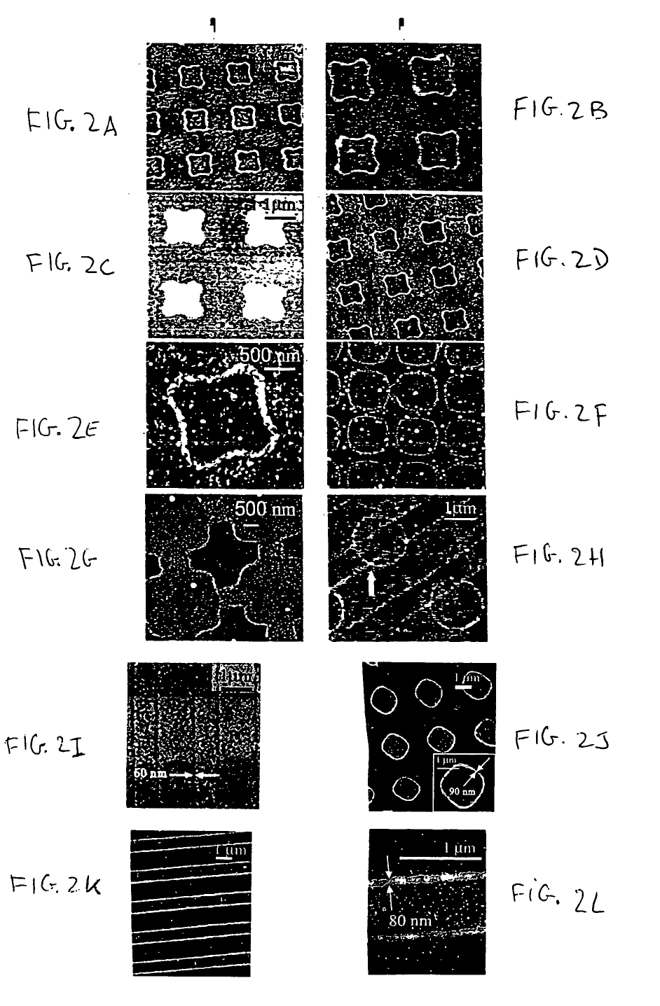

Using ETL, patterns having nanoscale resolution are formed primarily by the transfer of molecular ink along the edges 19 of the protruding features 16 of the stamp structure surface 11 rather than from the stamp surfaces 14. As a result, the pattern that is formed on the substrate surface reflects the outline of the preexisting patterns of the stamp surfaces 14. For example, lateral force microscopy (LFM) images, shown in FIGS. 2A and 2B, show that clover-shaped SAM structures are formed on a surface of a glass substrate when using a stamp structure 10 having stamp surfaces 14 in the form of an array of 1 μm clover-shaped wells. The molecular ink used to form the patterns shown in FIGS. 2A and 2B is dimethyldodecylchlorosilane (DDCS). No external pressure is applied to the stamp structure 10 during transfer of the molecular ink to form the patterns of FIGS. 2A and 2B. LFM is a contact mode scanning probe method which is sensitive to chemical variations at the surface and has been used to image SAMs as described, for example, in Gauthier, S., Aime, J. P., Bouhacina, T., Attias, A. J., and Desbat, B., “Study of Grafted Silane Monolayers on Silica Surface with an Atomic Force Microscope,” Langmuir, Vol. 12 (1996), 5126-37. LFM data were collected using ThermoMicroscopes Explorer (probe part #1500-00A) and CP-Research Autoprobe (probe Microlever B) instruments. The brighter regions in the images shown in FIGS. 2A and 2B correspond to areas of decreased frictional force between the tip of the scanning probe and the substrate surface, and therefore show the location and line width of the SAM of the molecular ink. A survey of many ETL patterns formed on substrate surfaces under similar conditions revealed average line widths at full-width half-maximum of 100 nm, with lines as narrow as 60 nm being observed. As pressure is applied to the stamp during the molecular ink transfer, the SAM patterns start to be filled in due to the molecular ink being squeezed out of the recesses 12 onto the stamp surfaces 14, and with excess pressure, the structures shown in FIG. 2C are obtained. High resolution patterns are also obtained if the PDMS stamp contains an array of lines rather than clover-shaped wells. FIG. 2I shows stamp surface edge structures with average line widths at full-width half-maximum of 100 nm and with some widths as small as 60 nm.

Similar results are obtained if the ETL pattern is formed using TiO₂ nanoparticles (˜5 nm in diameter) as the molecular ink. FIG. 2J shows a non-contact high resolution AFM (“NC-AFM”) image of oblate circles of TiO₂ particles obtained with a stamp structure surface 11 having protruding features 16 in the form of 1.5 μm oblate circles. NC-AFM is an extremely sensitive method for determining surface coverage of monolayer films and the heights of SAMs, described, for example, in Vallant, T., et al., “Formation of Self-Assembled Octadecylsiloxane Monolayers on Mica and Silicon Surfaces studied by Atomic Force Microscopy and Infrared Spectroscopy,” Journal of Physical Chemistry B, Vol. 102 (1998), 7190-97. The line-width at full-width half-maximum of the oblate circles in FIG. 2J is 90 nm.

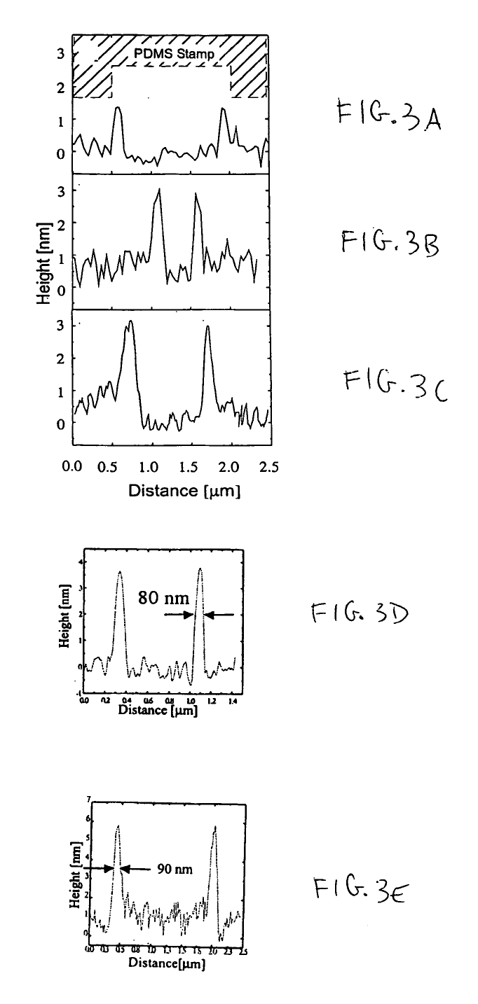

NC-AFM was also used to produce the images of clover-shaped DDCS SAMs shown in FIGS. 2D and 2E and to reveal the height, width, and texture of the SAMs. NC-AFM data were collected using ThermoMicroscopes Explorer (probe part #1660-00 and 1650-00) and CP-Research Autoprobe (probe dLever A) instruments. These images reveal an average height of the patterned outlines relative to the bare glass surface of 1.3 nm and an average line width at full-width half-maximum of 100 nm. FIG. 3A shows a topographic line scan plot obtained from image 2E. The outline at the top of the scan of FIG. 3A shows where the PDMS stamp contacted the substrate surface 18. The measured height of the outline of the pattern is less than the 1.6 nm expected for a tightly packed SAM of dodecyl siloxane covalently bound to and projecting vertically from the surface of the substrate, which suggests a certain degree of tilt or disorder which is not uncommon in such structures. In contrast, the average height in the region where the PDMS stamp surface 14 rested on or near the substrate during stamping measures only 0.2 nm above the bare glass surface. This very small value is only slightly above the noise level of the instrument and is believed to be due to partial silylation in this region, with molecules lying about parallel, rather than perpendicular, to the substrate surface. These data clearly indicate that discontinuous dewetting of PDMS stamps with alkylsilane alcohol solutions leaves the alkylsilane available for delivery along the edges of the protruding features 16 of the stamp structure surface 11, with little, if any, alkylsilane on the stamp surfaces 14 of the protruding features. Similar data were obtained for TiO₂. FIG. 3D shows a topographic line scan plot obtained for the pattern whose image is shown in FIG. 2J. The observed AFM height of slightly more than 5 nm indicates that a single layer of TiO₂ nanoparticles is present. Nearly all of the nanoparticles are delivered at the edges of the stamp surfaces 14, although a very small amount of deposition also occurs in the stamp surface contact region within the edges, unlike the case of alkylsilanes. A possible reason for this difference between TiO₂ nanoparticles and alkylsilanes is that alkylsilane molecules on the surface of the protruding features 16 of the stamp structure 10 may degrade by exposure to water and may be absorbed into the PDMS stamp, while TiO₂ nanoparticles remain unaffected on the stamp surfaces 14 of the protruding features 16 of the stamp structure 10 and may be therefore transferred to the substrate.

Self-assembled monolayers can also be used for the guided assembly of molecular materials, as discussed, for example, in Huang, Z., Wang, P. C., MacDiarmid, A. G., Xia, Y., and Whitesides, G. M., “Selective Deposition of Conducting Polymers on Hydroxyl-Terminated Surfaces with Printed Monolayers of Alkylsiloxanes as Templates,” Langmuir, Vol. 13 (1997), 6480-85; Gupta, V. K., and Abbott, N. L., “Using Droplets of Nematic Liquid Crystals to Probe the Microscopic and Mesoscopic Structure of Organic Surfaces,” Langmuir, Vol. 15 (1999), 7213-23; Drawhorn, R. A., and Abbott, N. A., “Anchoring of Nematic Liquid Crystals on Self-Assembled Monolayers formed from Alkanethiols on Semitransparent Films of Gold,” Journal of Physical Chemistry, Vol. 99 (1995), 16511-15; Aizenberg, J., Black, A. J., and Whitesides, G. M., “Control of Crystal Nucleation by Self-Assembled Monolayers,” Nature, Vol. 398 (1999), 495-97; and Liu, J., et al., “Controlled Deposition of Individual Single-Walled Carbon Nanotubes on Chemically Functionalized Templates,” Chemical Physics Letters, Vol. 303 (1999), 125-29. We have found that deposition of monolayers of certain substances onto the patterned surfaces results in complex patterned layered systems where molecules of the substance selectively organize onto the nanoscale SAM regions. Preferred substances are nanoparticles of metallic compounds, such as CdSe capped with trioctylphosphine (TOPO), preferably about 3-6 nm in diameter, and liquid crystal materials, such as perylenes, and in particular N,N′-bis[3-[2-[2-(1-butoxy)ethoxy]ethoxy]propyl]perylene-3,4,9,10-tetracarboxyldiimide (PPEEB). The combined liquid crystal/SAM assemblies were imaged by NC-AFM. FIGS. 2F and 2G show NC-AFM images of patterns formed by depositing liquid crystal perylenes from dilute solutions (<1 mM) onto various SAM patterned surfaces. The liquid crystal/SAM assembly of FIG. 2F is prepared by casting a dilute solution of liquid crystal perylene onto a substrate surface patterned by ETL with DDCS. The liquid crystal solution is prepared as described by Cormier, R. A., and Gregg, B. A., “Self-Organization in Thin Films of Liquid Crystalline Perylene Diimides,” Journal of Physical Chemistry B, Vol. 101 (1997), pp. 11004-06. “Casting” as used herein refers to placing several drops of a dilute solution in a solvent of the substance to be deposited on the patterned substrate which is then placed in an atmosphere saturated with the solvent, thereby ensuring slow evaporation of the solvent from the substrate. The solvent used is typically tetrahydrofuran (THF) for perylene derivatives and chloroform for CdSe particles. Preferred casting concentrations are about 0.01 mg/ml for a perylene such as PPEEB in THF, and about 10⁻⁷ M for CdSe in chloroform. The liquid crystal/SAM assembly of FIG. 2G is prepared by spin-coating a liquid crystal solution of perylene onto a surface patterned by ETL. “Spin-coating” as used herein refers to placing at least one drop of a dilute solution in a solvent of the substance to be deposited on the patterned substrate as the substrate spins at about 2000 rpm. Preferred concentrations for spin-coating are about 2.5 mg/ml for a perylene such as PPEEB in THF, and about 10⁻⁶ M for CdSe in chloroform. Another technique that may be used is “dip-coating”, which involves immersing a patterned substrate in a solution of the substance to be deposited for about 2-5 hours. Preferred concentrations for dip-coating are about 0.1 mg/ml for a perylene such as PPEEB in THF, and about 10⁻⁷ M for CdSe in chloroform. FIGS. 2K and 2L show NC-AFM images of CdSe nanoparticles self-assembled onto the ETL patterned lines of FIG. 2I to form 80 nm line-width structures. Regardless of the deposition technique used, following the deposition the substrates are rinsed with the same solvent used in the deposition step and dried under nitrogen.

Height analysis of assemblies of SAM and liquid crystals, of assemblies of SAMs and metallic substances or metal-containing compounds, and of metallic substances or metal-containing compounds patterned on a substrate surface shows a height increase only along the patterned lines. Topographic line scan plots for the liquid crystal/SAM assemblies of FIGS. 2F, 2G, and 2L are shown in FIGS. 3B, 3C, and 3E, respectively. In FIG. 3B, a height increase is observed only on the ETL patterned SAM/liquid crystal assemblies. The average height of the raised outline features relative to the bare glass is 2.8 nm, which corresponds to no more than one molecular length of the perylene liquid crystal interdigitated with an alkylsilane SAM, as shown schematically in FIG. 1D. FIG. 3C shows that in addition to the distinct edge height characteristic of the assembly, other regions of the substrate attract some liquid crystalline material, resulting in an average rise of 0.4 nm from bare glass level. This small rise is believed to be due to the presence of partially silylated regions, as discussed above in the context of FIG. 2E, onto which a small amount of liquid crystals is deposited. FIG. 3D shows that the patterned lines rise ˜4 nm above the surface, which is consistent with at most one layer of organically capped CdSe particles deposited onto the patterned SAMs, shown schematically in FIG. 1E. These images clearly reveal that the nanoparticles preferentially assemble in monolayers in the regions of the molecular ink edge structures.

ETL can be used to form a molecular ink pattern containing arrays of four-way or higher order junctions by multiple applications of one or more stamps. FIG. 2H shows a NC-AFM image of a pattern containing four-way junctions created by applying on a glass substrate stamp surfaces 14 in the form of 1 μm wide lines followed by stamp surfaces 14 in the form of 1.5 μm diameter circles. The order in which the stamp surfaces are applied is not critical. The white arrow points at a four-way junction. A DDCS concentration of about 1% was used to pattern the substrate, resulting in line widths of only 50-60 nm thickness. A very dilute solution of liquid crystal perylene diimide was spin-coated onto the substrate to enhance the height of the features shown in FIG. 2H. Therefore, ETL can be used to form a pattern on a substrate surface by performing the steps of the method of the invention described above using a first material and a first molecular ink dissolved in a first solvent, and repeating these steps a multiple number of times, each time using a material, molecular ink, and solvent which may be the same as or different from a previously used material, molecular ink, and solvent, respectively. Piezo-driven nanopositioning and stamping would allow for precision multi-ink printing similar to a printing press. The ability to stamp multiple times allows for the possibility of applying different inks on the same surface to create multi-functional patterns, similar to multi-pen DPN.

The line widths obtained with ETL depend on humidity. Narrower lines were observed when ETL was performed under less humid conditions. Relative humidity likely affects the transport rate of alkylsilane to the surface, as in DPN. Water has also been shown to be essential for the reactivity of chloro- and methoxy-silanes with silica to from stable SAMs, as discussed, for example, in Angst, D. L., and Simmons, G. W., “Moisture Absorption Characteristics of Organosiloxane Self-Assembled Monolayers,” Langmuir, Vol. 7 (1991), 2236-42. The size of the water meniscus is also critically dependent on the humidity, as disclosed in Piner, R. D., and Mirkin, C. A., “Effect of Water on Lateral Force Microscopy in Air,” Langmuir, Vol. 13 (1997), 6864-68. The ink concentration, stamp substrate contact time, pressure applied to the stamp, SAM annealing procedure, nature of the silane reagent, and the substrate condition/topography all affect the line widths and SAM structure. Alkylsilanes have varying degrees of reactivity depending on the nature of the leaving group(s), while chain lengths are known to affect their diffusion rates.

An explanation of the mechanism for the method of the invention is as follows. Without wishing to be bound by this or any other mechanism or theory, as the stamp surface 14 is brought into contact with the surface of a substrate 18, as shown in FIG. 1A, the alkylsilane is delivered from the recesses 12 to the substrate surface 18 along the one-dimensional edges 19 of the protruding features 16, thereby producing large area patterns with nanoscale features. The molecular ink is transported from the recess 12 of the stamp structure surface 11 to the surface of the substrate 18 via a meniscus of water 21 which is adsorbed in the inner recess 12 of the stamp structure surface 11, as shown schematically in FIG. 1B. The transported alkylsilane molecules then anchor themselves on the substrate and form stable monolayers by reacting with hydroxy groups on the substrate.

The invention is further illustrated by, though not limited to, the following Examples which are conducted under ambient conditions at a humidity of between 20% and 40%.

### EXAMPLE 1

### Application of Dimethyloctadecylmethoxy Silane (DOMS) to a Glass Surface

PDMS (Sylgard 184 Elastomer Kit, available from Dow Corning) stamps are molded on patterned silicon wafers using standard methods such as described in Xia, X., and Whitesides, G. M., “Soft lithography,” Angewandte Chemie International Edition in English, Vol. 37 (1998), pp. 550-74. The stamp is inked lightly with a 2% by volume solution of DOMS (90% pure used as purchased from Fluka) in anhydrous methanol or ethanol (both available from Aldrich) using a cotton swab. The residual solvent is removed by blow-drying with N₂. The stamp is immediately brought in contact with a glass slide (available from Corning), freshly cleaned with piranha solution, which consists of 7:3 volume/volume 98% H₂SO₄ and 30% H₂O₂ No external pressure is applied to the stamp structure 10 or the substrate. The assembly is baked for ˜30 min at 70° C. after which the stamp is removed and the substrate is thoroughly rinsed with methanol.

### EXAMPLE 2

### Application of Dimethyldodecylchlorosilane (DDCS) to a Glass Surface

The experiment is performed in the same way as in Example 1 but using DDCS (90% pure used as purchased from Fluka) instead of DOMS.

It should be understood that various changes and modifications to the preferred embodiments described herein will be apparent to those skilled in the art. Such changes and modifications can be made without departing from the spirit and scope of this invention, the scope being defined by the appended claims.

1. A method for applying a nanoscale resolution pattern of a molecular ink onto a surface of a substrate comprising:
a) providing a stamp structure having a surface with at least one protruding feature, each protruding feature extending from the surface of the stamp structure by a common distance, each protruding feature having a stamp surface of a respective predefined shape at a protruding end thereof, each protruding feature and its stamp surface being bounded by at least one edge, each edge intersecting the surface of the stamp structure to form a recess;
b) applying a solution of the molecular ink and a solvent to the surface of the stamp structure, including each stamp surface, wherein the solution and the material of the surface of the stamp structure are such that the solution dewets from the surface of the stamp structure, including each stamp surface, so as to accumulate in each recess;
c) drying the surface of the stamp substrate, including each stamp surface, to evaporate the solvent and leave the molecular ink in each recess with substantially no molecular ink left on each stamp surface; and
d) bringing each stamp surface in contact with the surface of the substrate to transfer the molecular ink from each recess to the surface of the substrate along each edge of each protruding feature so as to deposit a nanoscale resolution pattern of the molecular ink on the surface of the substrate.

2. The method of claim 1, wherein the material of the surface of the stamp structure, including each protruding feature thereof, is an elastomeric material.

3. The method of claim 1, wherein the material of the surface of the stamp structure, including each protruding feature thereof, is a polymeric material.

4. The method of claim 3, wherein the polymeric material is polydimethoxysilane.

5. The method of claim 1, wherein the solvent is a polar solvent.

6. The method of claim 5, wherein the polar solvent causes substantially no swelling of the surface of the stamp structure and each protruding feature thereof.

7. The method of claim 1, wherein the molecular ink is a compound capable of forming self-assembled monolayers on the substrate surface and capable of reacting with hydroxy groups and with water.

8. The method of claim 7, wherein the compound capable of forming self-assembled monolayers is an alkylsilane with a polar group.

9. The method of claim 8, wherein the alkylsilane is selected from the group consisting of monochloro alkylsilanes and monoalkoxy alkylsilanes.

10. The method of claim 7, wherein the compound capable of forming self-assembled monolayers is a metallic compound soluble in one of a liquid alcohol and a mixture of water and a liquid alcohol.

11. The method of claim 10, wherein the metallic compound is titanium dioxide.

12. The method of claim 11, wherein the titanium dioxide is in the form of nanoparticles ranging from about 3 to about 7 nm in diameter.

13. The method of claim 1, wherein step (c) comprises blow drying the surface of the stamp structure, including each protruding feature thereof, to evaporate the solvent.

14. The method of claim 1, wherein the substrate comprises a material selected from the group consisting of glass, a polymeric material, and a ceramic.

15. The method of claim 1, wherein no external pressure is applied to the stamp structure or the substrate in step (d).

16. A method for applying a nanoscale resolution pattern of a molecular ink onto a surface of a substrate and depositing a monolayer of a substance on the pattern of the molecular ink on the surface of the substrate comprising:
a) providing a stamp structure having a surface with at least one protruding feature, each protruding feature extending from the surface of the stamp structure by a common distance, each protruding feature having a stamp surface of a respective predefined shape at a protruding end thereof, each protruding feature and its stamp surface being bounded by at least one edge, each edge intersecting the surface of the stamp structure to form a recess;
b) applying a solution of the molecular ink and a solvent to the surface of the stamp structure, including each stamp surface, wherein the solution and the material of the surface of the stamp structure are such that the solution dewets from the surface of the stamp structure, including each stamp surface, so as to accumulate in each recess;
c) drying the surface of the stamp structure, including each stamp surface, to evaporate the solvent and leave the molecular ink in each recess while leaving substantially no molecular ink on each stamp surface;
d) bringing each stamp surface in contact with the surface of the substrate to transfer the molecular ink from each recess to the surface of the substrate along each edge of each protruding feature so as to form a nanoscale resolution pattern of the molecular ink on the surface of the substrate, wherein the molecular ink is covalently bound to the surface of the substrate; and
e) depositing a monolayer of the substance on the pattern of the molecular ink on the surface of the substrate from a solution containing the substance using one of casting, spin-coating and dip-coating.

17. The method of claim 16, wherein the material of the surface of the stamp structure, including each protruding feature thereof, is an elastomeric material.

18. The method of claim 16, wherein the material of the surface of the stamp structure, including each protruding feature thereof, is a polymeric material.

19. The method of claim 16, wherein the solvent is a polar solvent.

20. The method of claim 16, wherein the molecular ink is a compound capable of forming self-assembled monolayers on the substrate surface and capable of reacting with hydroxy groups and with water.

21. The method of claim 20, wherein the compound capable of forming self-assembled monolayers is an alkylsilane.

22. The method of claim 20, wherein the compound capable of forming self-assembled monolayers is a metallic compound soluble in one a liquid alcohol and a mixture of water and a liquid alcohol.

23. The method of claim 16, wherein step (c) comprises blow drying the surface of the stamp structure, including each protruding feature thereof, to evaporate the solvent.

24. The method of claim 16, wherein the substrate comprises a material selected from the group consisting of glass, a polymeric material, and a ceramic.

25. The method of claim 16, wherein no external pressure is applied to the stamp structure on the substrate in step (d).

26. The method of claim 16, wherein the substance is a liquid crystal material.

27. The method of claim 16, wherein the substance comprises nanoparticles of a metallic compound.

28. An article of manufacture comprising a substrate having a nanoscale resolution pattern of a molecular ink applied to a surface thereof, the article being prepared by a method comprising:
a) providing a stamp structuring having a surface with at least one protruding feature, each protruding feature extending from the surface of the stamp structure by a common distance, each protruding feature having a stamp surface of a respective predefined shape at a protruding end thereof, each protruding feature and its stamp surface being bounded by at least one edge, each edge intersecting the surface of the stamp structure to form a recess;
b) applying a solution of the molecular ink and a solvent to the surface of the stamp structure, including each stamp surface, wherein the solution and the material of the surface of the stamp structure are such that the solution dewets from the surface of the stamp structure, including each stamp surface, so as to accumulate in each recess;
c) drying the surface of the stamp structure, including each stamp surface, to evaporate the solvent and leave the molecular ink in each recess while leaving substantially no molecular ink on each stamp surface; and
d) bringing each stamp surface in contact with the surface of the substrate to transfer the molecular ink from each recess to the surface of the substrate along each edge of each protruding feature so as to apply a nanoscale resolution pattern of the molecular ink on the surface of the substrate.

29. The method of claim 28, wherein the material of the surface of the stamp structure, including each protruding feature thereof, is an elastomeric material.

30. The method of claim 28, wherein the material of the surface of the stamp structure, including each protruding feature thereof, is a polymeric material.

31. The method of claim 30, wherein the polymeric material is polydimethoxysilane.

32. The method of claim 28, wherein the solvent is a polar solvent.

33. The method of claim 32, wherein the polar solvent causes substantially no swelling of the surface of the stamp structure and each protruding feature thereof.

34. The method of claim 28, wherein the molecular ink is a compound capable of forming self-assembled monolayers on the substrate surface and capable of reacting with hydroxy groups and with water.

35. The method of claim 34, wherein the compound capable of forming self-assembled monolayers is an alkylsilane with a polar group.

36. The method of claim 35, wherein the alkylsilane is selected from the group consisting of monochloro alkylsilanes and monoalkoxy alkylsilanes.

37. The method of claim 34, wherein the compound capable of forming self-assembled monolayers is a metallic compound soluble in one a liquid alcohol and a mixture of water and a liquid alcohol.

38. The method of claim 37, wherein the metallic compound is titanium dioxide.

39. The method of claim 38, wherein the titanium dioxide is in the form of nanoparticles ranging from about 3 to about 7 nm in diameter.

40. The method of claim 28, wherein step (c) comprises blow drying the surface of the stamp structure, including each protruding feature thereof, to evaporate the solvent.

41. The method of claim 28, wherein the substrate comprises a material selected from the group consisting of glass, a polymeric material, and a ceramic.

42. The method of claim 28, wherein no external pressure is applied to the stamp structure or the substrate in step (d).
